(19) United States
(12) Patent Application Publication
(10) Pub. No.: US 2022/0361147 A1
(43) Pub. Date: Nov. 10, 2022

(54) SIDELINK INTER-USER EQUIPMENT COORDINATION USING DESIGNATED RESOURCES

(71) Applicant: QUALCOMM Incorporated, San Diego, CA (US)

(72) Inventors: Gabi SARKIS, San Diego, CA (US); Seyedkianoush HOSSEINI, San Diego, CA (US); Tien Viet NGUYEN, Bridgewater, NJ (US); Sourjya DUTTA, San Diego, CA (US)

(21) Appl. No.: 17/659,435

(22) Filed: Apr. 15, 2022

Related U.S. Application Data
(60) Provisional application No. 63/185,891, filed on May 7, 2021.

(51) Int. Cl. H04W 72/02; H04W 72/04; H04W 72/10

(52) U.S. Cl. CPC H04W 72/02; H04W 72/0446; H04W 72/0453; H04W 72/0406; H04W 72/10

(57) ABSTRACT

Various aspects of the present disclosure generally relate to wireless communication. In some aspects, a user equipment (UE) may identify a set of resources that are designated for sidelink inter-UE coordination information based at least in part on a sidelink resource pool configuration. The UE may transmit or monitor for a communication that includes inter-UE coordination information in a resource of the set of resources. Numerous other aspects are described.

### CROSS-REFERENCE TO RELATED APPLICATION

This Patent Application claims priority to U.S. Provisional Patent Application No. 63/185,891, filed on May 7, 2021, entitled “SIDELINK INTER-USER EQUIPMENT COORDINATION USING DESIGNATED RESOURCES,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for sidelink inter-user equipment coordination using designated resources.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a user equipment (UE) includes identifying a set of resources that are designated for sidelink inter-UE coordination information based at least in part on a sidelink resource pool configuration; and transmitting or monitoring for a communication that includes inter-UE coordination information in a resource of the set of resources.

In some aspects, a UE for wireless communication includes a memory and one or more processors, coupled to the memory, configured to identify a set of resources that are designated for sidelink inter-UE coordination information based at least in part on a sidelink resource pool configuration; and transmit or monitor for a communication that includes inter-UE coordination information in a resource of the set of resources.

In some aspects, a non-transitory computer-readable medium storing a set of instructions for wireless communication includes one or more instructions that, when executed by one or more processors of a UE, cause the UE to identify a set of resources that are designated for sidelink inter-UE coordination information based at least in part on a sidelink resource pool configuration; and transmit or monitor for a communication that includes inter-UE coordination information in a resource of the set of resources.

In some aspects, an apparatus for wireless communication includes means for identifying a set of resources that are designated for sidelink inter-UE coordination information based at least in part on a sidelink resource pool configuration; and means for transmitting or monitoring for a communication that includes inter-UE coordination information in a resource of the set of resources.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of sidelink communications, in accordance with the present disclosure.

FIG. 4 is a diagram illustrating an example of sidelink communications and access link communications, in accordance with the present disclosure.

FIG. 5 is a diagram illustrating an example of sidelink coordination signaling, in accordance with the present disclosure.

FIG. 6 is a diagram illustrating an example of sidelink resource reservation and coordination signaling, in accordance with the present disclosure.

FIG. 7 is a diagram illustrating an example associated with sidelink inter-UE coordination using designated resources, in accordance with the present disclosure.

FIG. 8 is a diagram illustrating another example associated with sidelink inter-UE coordination using designated resources, in accordance with the present disclosure.

FIG. 9 is a diagram illustrating an example process associated with sidelink inter-UE coordination using designated resources, in accordance with the present disclosure.

FIG. 10 is a block diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

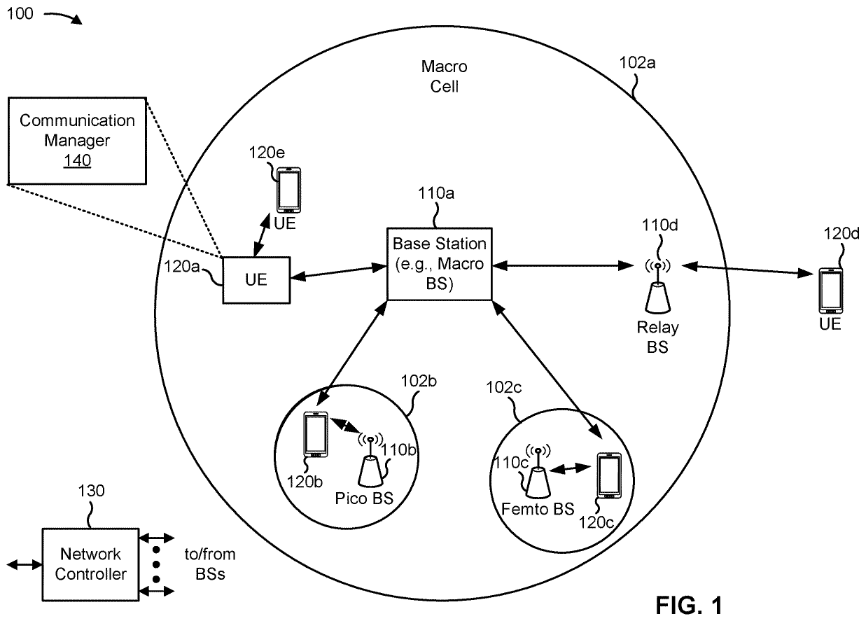

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some aspects, the term “base station” (e.g., the base station 110) or “network entity” may refer to an aggregated base station, a disaggregated base station, an integrated access and backhaul (IAB) node, a relay node, and/or one or more components thereof. For example, in some aspects, “base station” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station” or “network entity” may refer to one device configured to perform one or more functions, such as those described herein in connection with the base station 110. In some aspects, the term “base station” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station” or “network entity” may refer to any one or more of those different devices. In some aspects, the term “base station” or “network entity” may refer to one or more virtual base stations and/or one or more virtual base station functions. For example, in some aspects, two or more base station functions may be instantiated on a single device. In some aspects, the term “base station” or “network entity” may refer to one of the base station functions and not another. In this way, a single device may include more than one base station.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., UE 120) may include a communication manager 140. As described in more detail elsewhere herein, the communication manager 140 may identify a set of resources that are designated for sidelink inter-UE coordination information based at least in part on a sidelink resource pool configuration; and transmit or monitor for a communication that includes inter-UE coordination information in a resource of the set of resources. Additionally, or alternatively, the communication manager 140 may perform one or more other operations described herein.

As indicated above, FIG. 1 is provided as an example. Other examples may differ from what is described with regard to FIG. 1.

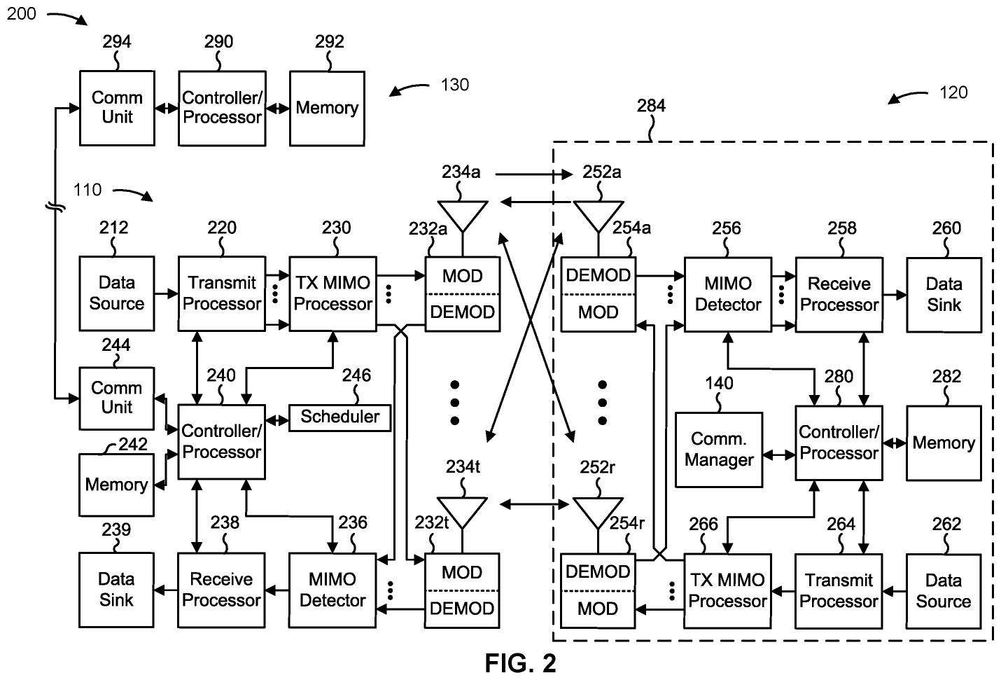

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

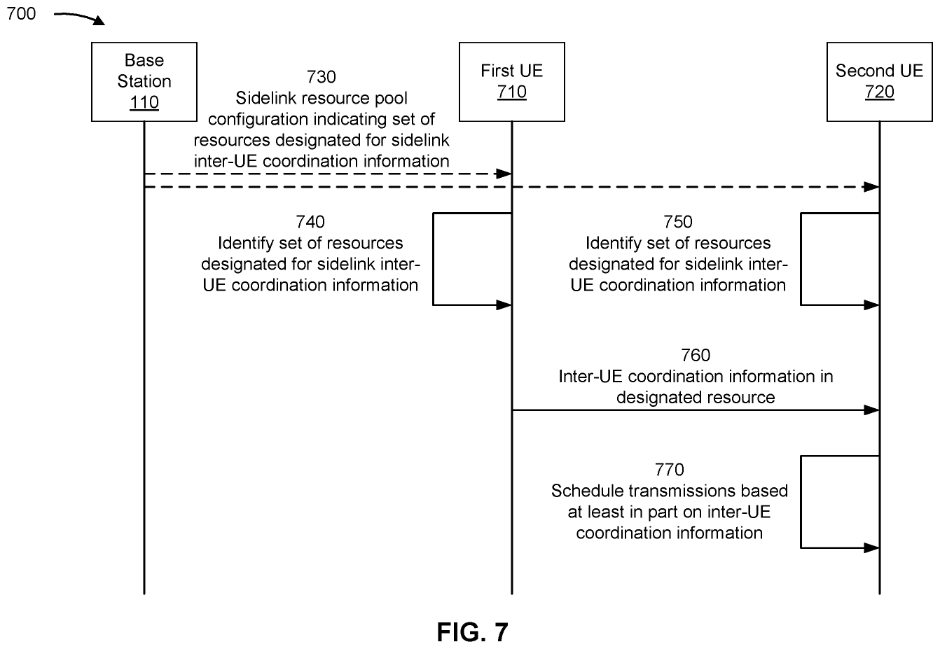

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7-9).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7-9).

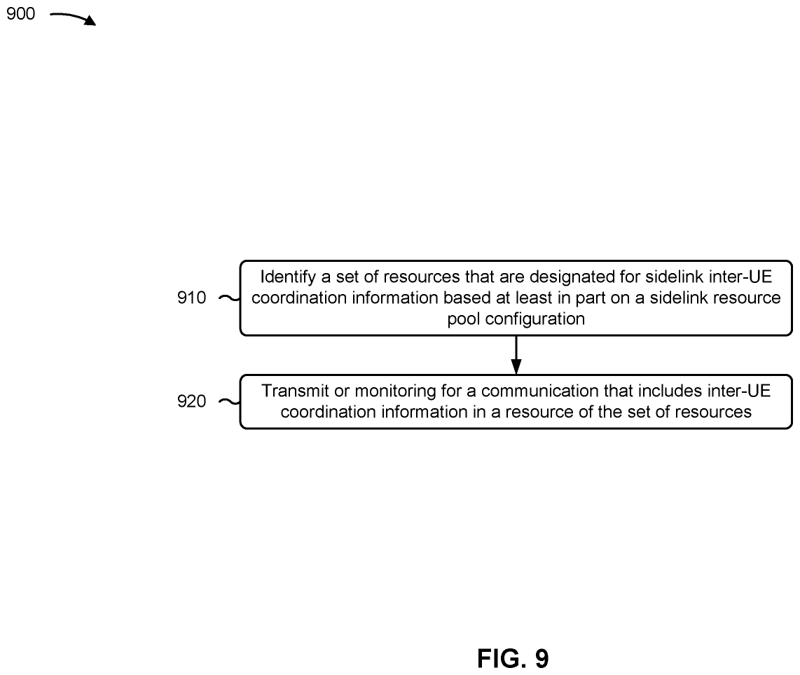

The controller/processor 240 of the base station 110, the controller/processor 280 of the UE 120, and/or any other component(s) of FIG. 2 may perform one or more techniques associated with sidelink inter-UE coordination using designated resources as described in more detail elsewhere herein. For example, the controller/processor 240 of the base station 110, the controller/processor 280 of the UE 120, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 900 of FIG. 9 and/or other processes as described herein. In some examples, executing instructions may include running the instructions, converting the instructions, compiling the instructions, and/or interpreting the instructions, among other examples.

In some aspects, a UE (e.g., UE 120) includes means for identifying a set of resources that are designated for sidelink inter-UE coordination information based at least in part on a sidelink resource pool configuration; and/or means for transmitting or monitoring for a communication that includes inter-UE coordination information in a resource of the set of resources. The means for the UE 120 to perform operations described herein may include, for example, one or more of communication manager 140, antenna 252, demodulator 254, MIMO detector 256, receive processor 258, transmit processor 264, TX MIMO processor 266, modulator 254, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

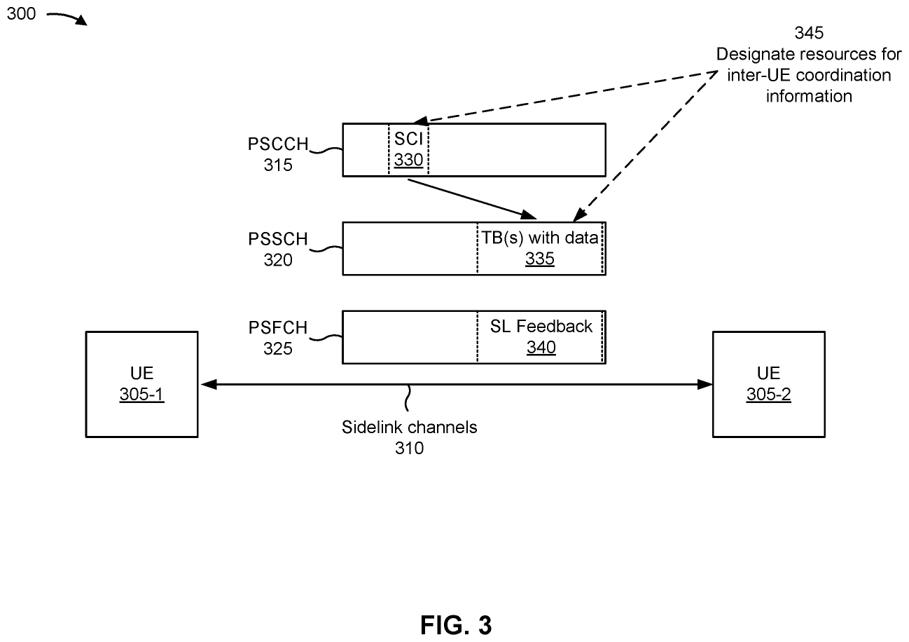

FIG. 3 is a diagram illustrating an example 300 of sidelink communications, in accordance with the present disclosure.

As shown in FIG. 3, a first UE 305-1 may communicate with a second UE 305-2 (and one or more other UEs 305) via one or more sidelink channels 310. The first UE 305-1 and the second UE 305-2 may communicate using the one or more sidelink channels 310 for P2P communications, D2D communications, V2X communications (e.g., which may include V2V communications, V2I communications, and/or V2P communications) and/or mesh networking. In some aspects, the UEs 305 (e.g., the first UE 305-1 and/or the second UE 305-2) may correspond to one or more other UEs described elsewhere herein, such as UE 120. In some aspects, the one or more sidelink channels 310 may use a PC5 interface and/or may operate in a high frequency band (e.g., the 5.9 GHz band). Additionally, or alternatively, the UEs 305 may synchronize timing of transmission time intervals (TTIs) (e.g., frames, subframes, slots, or symbols) using global navigation satellite system (GNSS) timing.

As further shown in FIG. 3, the one or more sidelink channels 310 may include a physical sidelink control channel (PSCCH) 315, a physical sidelink shared channel (PSSCH) 320, and/or a physical sidelink feedback channel (PSFCH) 325. The PSCCH 315 may be used to communicate control information, similar to a physical downlink control channel (PDCCH) and/or a physical uplink control channel (PUCCH) used for cellular communications with a base station 110 via an access link or an access channel. The PSSCH 320 may be used to communicate data, similar to a physical downlink shared channel (PDSCH) and/or a physical uplink shared channel (PUSCH) used for cellular communications with a base station 110 via an access link or an access channel. For example, the PSCCH 315 may carry sidelink control information (SCI) 330, which may indicate various control information used for sidelink communications, such as one or more resources (e.g., time resources, frequency resources, and/or spatial resources) where a transport block (TB) 335 may be carried on the PSSCH 320. The TB 335 may include data. The PSFCH 325 may be used to communicate sidelink feedback 340, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 315, in some aspects, the SCI 330 may include multiple communications in different stages, such as a first stage SCI (SCI-1) and a second stage SCI (SCI-2). The SCI-1 may be transmitted on the PSCCH 315. The SCI-2 may be transmitted on the PSSCH 320. The SCI-1 may include, for example, an indication of one or more resources (e.g., time resources, frequency resources, and/or spatial resources) on the PSSCH 320, information for decoding sidelink communications on the PSSCH, a quality of service (QoS) priority value, a resource reservation period, a PSSCH DMRS pattern, an SCI format for the SCI-2, a beta offset for the SCI-2, a quantity of PSSCH DMRS ports, and/or an MCS. The SCI-2 may include information associated with data transmissions on the PSSCH 320, such as a HARQ process identifier (ID), a new data indicator (NDI), a source identifier, a destination identifier, and/or a channel state information (CSI) report trigger.

In some aspects, the one or more sidelink channels 310 may use resource pools. For example, a scheduling assignment (e.g., included in SCI 330) may be transmitted in sub-channels using specific resource blocks (RBs) across time. In some aspects, data transmissions (e.g., on the PSSCH 320) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 305 may operate using a transmission mode where resource selection and/or scheduling is performed by the UE 305 (e.g., rather than a base station 110). In some aspects, the UE 305 may perform resource selection and/or scheduling by sensing channel availability for transmissions. For example, the UE 305 may measure an RSSI parameter (e.g., a sidelink-RSSI (S-RSSI) parameter) associated with various sidelink channels, may measure an RSRP parameter (e.g., a PSSCH-RSRP parameter) associated with various sidelink channels, and/or may measure an RSRQ parameter (e.g., a PSSCH-RSRQ parameter) associated with various sidelink channels, and may select a channel for transmission of a sidelink communication based at least in part on the measurement(s).

Additionally, or alternatively, the UE 305 may perform resource selection and/or scheduling using SCI 330 received in the PSCCH 315, which may indicate occupied resources and/or channel parameters. Additionally, or alternatively, the UE 305 may perform resource selection and/or scheduling by determining a channel busy ratio (CBR) associated with various sidelink channels, which may be used for rate control (e.g., by indicating a maximum number of resource blocks that the UE 305 can use for a particular set of subframes).

In the transmission mode where resource selection and/or scheduling is performed by a UE 305, the UE 305 may generate sidelink grants, and may transmit the grants in SCI 330. A sidelink grant may indicate, for example, one or more parameters (e.g., transmission parameters) to be used for an upcoming sidelink transmission, such as one or more resource blocks to be used for the upcoming sidelink transmission on the PSSCH 320 (e.g., for TBs 335), one or more subframes to be used for the upcoming sidelink transmission, and/or an MCS to be used for the upcoming sidelink transmission. In some aspects, a UE 305 may generate a sidelink grant that indicates one or more parameters for semi-persistent scheduling (SPS), such as a periodicity of a sidelink transmission. Additionally, or alternatively, the UE 305 may generate a sidelink grant for event-driven scheduling, such as for an on-demand sidelink message.

As shown by reference number 345, some techniques and apparatuses described herein enable resources for inter-UE coordination information (described in more detail elsewhere herein) to be designated (e.g., assigned, reserved, or dedicated). In some aspects, these resources may be on the PSCCH 315, such as in SCI-1. Additionally, or alternatively, these resources may be on the PSSCH 320, such as in SCI-2, in a medium access control (MAC) control element (CE) (collectively, MAC-CE), or in a radio resource control (RRC) message (e.g., a PC5-RRC message). Furthermore, some techniques and apparatuses described herein enable these resources to be designated for inter-UE coordination information in a manner that is backward compatible (e.g., with UEs that aren't configured for inter-UE coordination information). By designating these resources for inter-UE coordination information, latency may be reduced as compared to selecting resources for transmission of the inter-UE coordination information using a selection procedure (e.g., sensing and/or reporting) that does not include designated resources for inter-UE coordination information. As a result, resource conflicts and interference between sidelink communications may be reduced due to information carried in the inter-UE coordination information (which can be transmitted with lower latency).

As indicated above, FIG. 3 is provided as an example. Other examples may differ from what is described with respect to FIG. 3.

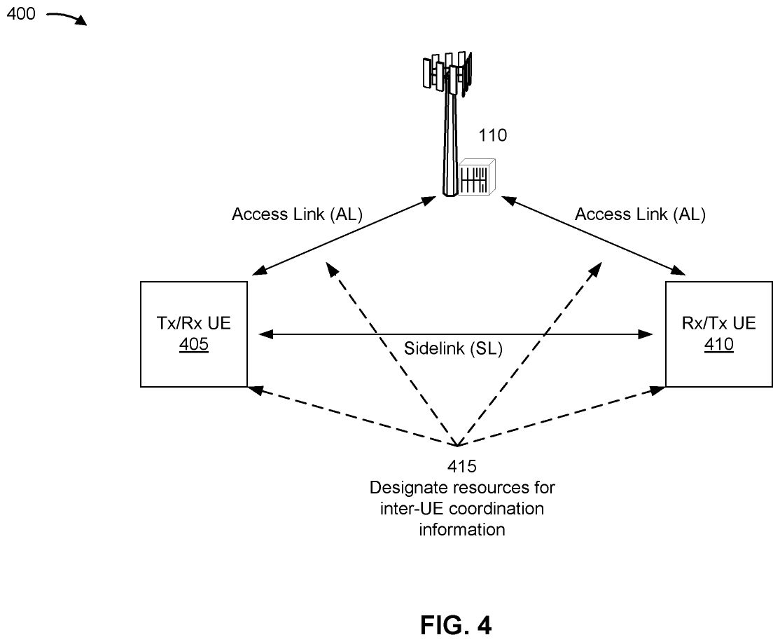

FIG. 4 is a diagram illustrating an example 400 of sidelink communications and access link communications, in accordance with the present disclosure.

As shown in FIG. 4, a transmitter (Tx)/receiver (Rx) UE 405 and an Rx/Tx UE 410 may communicate with one another via a sidelink, as described above in connection with FIG. 3. As further shown, in some sidelink modes, a base station 110 may communicate with the Tx/Rx UE 405 via a first access link. Additionally, or alternatively, in some sidelink modes, the base station 110 may communicate with the Rx/Tx UE 410 via a second access link. The Tx/Rx UE 405 and/or the Rx/Tx UE 410 may correspond to one or more UEs described elsewhere herein, such as the UE 120 of FIG. 1. Thus, a direct link between UEs 120 (e.g., via a PC5 interface) may be referred to as a sidelink, and a direct link between a base station 110 and a UE 120 (e.g., via a Uu interface) may be referred to as an access link. Sidelink communications may be transmitted via the sidelink, and access link communications may be transmitted via the access link. An access link communication may be either a downlink communication (from a base station 110 to a UE 120) or an uplink communication (from a UE 120 to a base station 110).

As shown by reference number 415, some techniques and apparatuses described herein enable resources for inter-UE coordination information (described in more detail elsewhere herein) to be designated (e.g., assigned, reserved, or dedicated). In some aspects, the resource designation (or resource reservation) may be based at least in part on a sidelink resource pool configuration received from a base station 110. Additionally, or alternatively, the resource designation may be based at least in part on a sidelink resource pool configuration stored in memory of a UE (e.g., UE 120, Tx/Rx UE 405, and/or Rx/Tx UE 410), such as a sidelink resource pool configuration hard coded in memory of the UE and/or that complies with a wireless communication standard If the sidelink resource pool configuration is received from a base station 110, this provides greater scheduling flexibility if the UE is in communication with a base station 110. However, if the sidelink resource pool configuration is hard coded in memory of the UE, this allows the UE 120 to designate resources for inter-UE coordination information even if the UE is not in communication with a base station 110.

As indicated above, FIG. 4 is provided as an example. Other examples may differ from what is described with respect to FIG. 4.

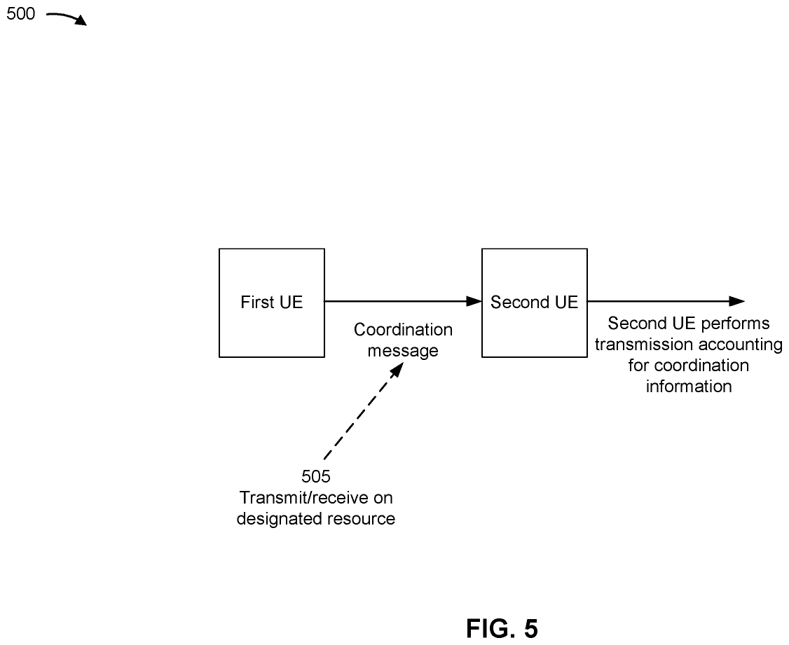

FIG. 5 is a diagram illustrating an example 500 of sidelink coordination signaling, in accordance with the present disclosure.

In example 500, a first UE (e.g., UE 120a of FIG. 1) exchanges inter-UE coordination signaling with a second UE (e.g., UE 120e of FIG. 1). The first UE and the second UE may operate in an in-coverage mode, a partial coverage mode, or an out-of-coverage mode with a base station 110. The first UE may determine a set of sidelink resources available for a resource allocation. The first UE may determine the set of sidelink resources based at least in part on determining that the set of sidelink resources are to be selected or based at least in part on a request, such as an inter-UE coordination request, received from the second UE or a base station 110. In some aspects, the first UE may determine the set of sidelink resources based at least in part on a sensing operation, which may be performed before receiving an inter-UE coordination request or after receiving the inter-UE coordination request.

The first UE may transmit an indication of the set of available resources to the second UE via inter-UE coordination signaling (shown as a coordination message and referred to in some aspects as an inter-UE coordination message or inter-UE coordination information). In some aspects, the first UE may transmit the indication of the set of available resources while operating in NR sidelink resource allocation mode 2. In NR sidelink resource allocation mode 2, resource allocation is handled by UEs (e.g., in comparison to NR sidelink resource allocation mode 1, in which resource allocation is handled by a scheduling entity, such as a base station 110). In some aspects, the indication of the set of available resources may identify resources that are preferred by the first UE for transmissions by the second UE. Alternatively, the indication of the set of available resources may identify resources that are not preferred by the first UE for transmissions by the second UE (e.g., with the available resources being those other than the resources that are not preferred). Additionally, or alternatively, the inter-UE coordination signaling may indicate a resource conflict (e.g., a collision), such as when two UEs have reserved the same resource (e.g., and were unable to detect this resource conflict because the two UEs transmitted a resource reservation message on the same resource and thus did not receive one another's resource reservation messages due to a half-duplex constraint). As used herein, a “resource conflict” may refer to a conflict in the time domain only, may refer to a conflict in both the time domain and the frequency domain, or may refer to a conflict in the time domain, the frequency domain, and the spatial domain

The second UE may select a sidelink resource for a transmission from the second UE based at least in part on the set of available resources indicated by the first UE. As shown, the second UE may account for the coordination information when transmitting (e.g., via a sidelink resource indicated as available by the inter-UE coordination message). Inter-UE coordination signaling related to resource allocation may reduce collisions between the first UE and the second UE and may reduce a power consumption for the first UE and/or the second UE (e.g., due to fewer retransmissions as a result of fewer collisions).

Although FIG. 5 shows a single first UE transmitting inter-UE coordination information to a single second UE, in some aspects, a single first UE may transmit inter-UE coordination information to multiple UEs to assist those UEs with selecting resources for transmissions. Additionally, or alternatively, the second UE may receive inter-UE coordination information from multiple UEs, and the second UE may use that information to select resources for a transmission (e.g., resources that avoid a resource conflict with all of the multiple UEs or as many as possible).

In some examples, the first UE may perform a sensing operation to determine a resource to be used to transmit the inter-UE coordination information. Additionally, or alternatively, the first UE may request and/or receive scheduling information from other UEs (e.g., via inter-UE coordination information or another message) and may use that scheduling information to determine a resource to be used to transmit the inter-UE coordination information. However, these techniques require processing by the first UE to determine the resource to be used to transmit the inter-UE coordination information, which results in a delayed transmission of the inter-UE coordination information.

As shown by reference number 505, some techniques and apparatuses described herein enable resources for inter-UE coordination to be designated (e.g., assigned, reserved, or dedicated). In this case, the inter-UE coordination information is transmitted and received in a designated resource (e.g., a resource dedicated to transmission of inter-UE coordination information, or a resource assigned to be used for transmission of inter-UE coordination information). This may reduce latency as compared to selecting resources for transmission of the inter-UE coordination information using a selection procedure (e.g., sensing and/or reporting) that does not include designated resources for inter-UE coordination information. As a result, resource conflicts and interference between sidelink communications may be reduced due to information carried in the inter-UE coordination information (which can be transmitted with lower latency). Furthermore, processing associated with performing a sensing operation and/or requesting or receiving scheduling information from other UEs may be reduced or eliminated, thus conserving resources of the UE (e.g., memory resources, processing resources, and/or battery power). Furthermore, signaling associated with determining a resource for transmission of inter-UE coordination information may be reduced, thus conserving network resources.

As indicated above, FIG. 5 is provided as an example. Other examples may differ from what is described with respect to FIG. 5.

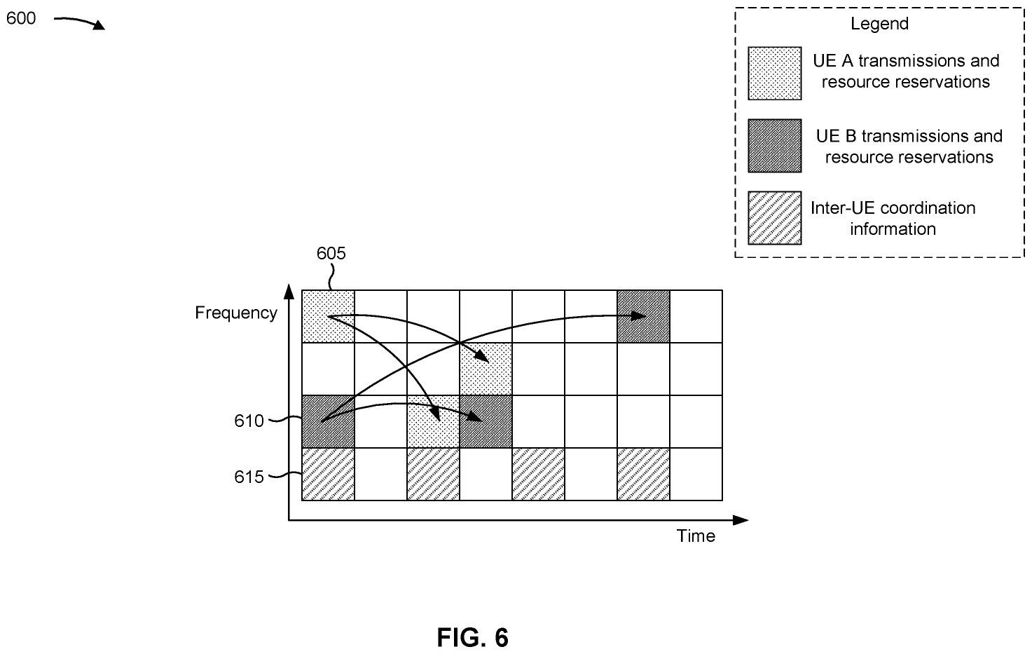

FIG. 6 is a diagram illustrating an example 600 of sidelink resource reservation and coordination signaling, in accordance with the present disclosure.

In NR sidelink, resource allocation is reservation-based, meaning that UEs can reserve time domain and frequency domain resources for later-occurring transmissions. For example, a UE may reserve one or more sub-channels in the frequency domain and one or more slots in the time domain As an example, a transmission by a UE may reserve resources (e.g., frequency resources) in the slot in which the transmission occurs, as well as in up to two later-occurring slots. The UE may reserve resources using reservation information, which may be carried in SCI. The resource reservation may be periodic (e.g., reserving multiple occasions over time) or aperiodic (e.g., reserving a single occasion). In some aspects, periodic reservations may be disabled.

For example, as shown by reference number 605, in sidelink communication, a first UE (e.g., UE A) may transmit in a first resource to reserve the first resource and up to two future resources (as an example). Similarly, as shown by reference number 610, a second UE (e.g., UE B) may transmit in a second resource to reserve the second resource and up to two future resources (as an example).

As shown by reference number 615, some techniques and apparatuses described herein enable resources for inter-UE coordination to be designated (e.g., assigned, reserved, or dedicated). In some aspects, if inter-UE coordination information is a single bit, such as to indicate a resource conflict (e.g., a collision), then that inter-UE coordination information may be transmitted on the PSFCH using a resource dedicated for inter-UE coordination information because PSFCH transmissions occupy a single resource block. However, if the inter-UE coordination information includes multiple bits, such as an indication of preferred or non-preferred resources, then this inter-UE coordination information cannot be transmitted on the PSFCH and could be transmitted on the PSCCH (e.g., in SCI-1) and/or the PSSCH (e.g., in SCI-2, a MAC-CE, and/or a PC5-RRC message).

For a transmission on the PSCCH and the PSSCH, resources are typically selected for the transmission using a sensing and/or by requesting and/or receiving scheduling information, as described above in connection with FIG. 5. However, these techniques require processing by the first UE to determine the resource(s) to be used to transmit the inter-UE coordination information, which results in a delayed transmission of the inter-UE coordination information.

Some techniques and apparatuses described herein enable resources for inter-UE coordination to be designated (e.g., assigned, reserved, or dedicated). In this case, the inter-UE coordination information is transmitted and received in a designated resource (e.g., a resource dedicated to transmission of inter-UE coordination information). Furthermore, some techniques and apparatuses described herein enable these resources to be designated for inter-UE coordination information in a manner that is backward compatible (e.g., with UEs that aren't configured for inter-UE coordination information). This may reduce latency, may reduce resource conflicts, may conserve resources of the UE (e.g., memory resources, processing resources, and/or battery power), and may conserve network resources, as described elsewhere herein.

As indicated above, FIG. 6 is provided as an example. Other examples may differ from what is described with respect to FIG. 6.

FIG. 7 is a diagram illustrating an example 700 associated with sidelink inter-UE coordination using designated resources, in accordance with the present disclosure. As shown in FIG. 7, a base station 110, a first UE 710, and a second UE 720 may communicate with one another. For example, the base station 110 may communicate with the first UE 710 via a first access link, the base station 110 may communicate with the second UE 720 via a second access link, and the first UE 710 and the second UE 720 may communicate with one another via a sidelink. The first UE 710 and the second UE 720 may be UEs 120 described elsewhere herein.

As shown by reference number 730, the base station 110 may transmit, to the first UE 710 and to the second UE 720, a sidelink resource pool configuration. The sidelink resource pool configuration may indicate a resource pool to be used for sidelink communications between UEs. For example, the base station 110 may designate a first set of resources for access link communications and may designate a second set of resources for sidelink communications. The sidelink resource pool configuration may indicate the second set of resources (e.g., a set of sidelink resources) to be used for sidelink communications, such as by indicating a frequency domain allocation for the sidelink resources (e.g., a number of sub-channels and a size of the sub-channels) and/or a time domain allocation for the sidelink resources (e.g., the slots to be used for sidelink communications). In some aspects, the sidelink resource pool configuration may be transmitted in an RRC message (e.g., an RRC configuration message or an RRC reconfiguration message). As used herein, a “designated resource” may refer to a resource that is reserved for a purpose (e.g., a type of transmission) and that is not to be used for another purpose (e.g., another type of transmission). Additionally, or alternatively, a “designated resource” may refer to a resource that is assigned for a purpose (e.g., a type of transmission), but that is still available for other purposes (e.g., other types of transmission). In some aspects, resources that are not designated for the purpose are not to be used for that purpose.

In some aspects, the sidelink resource pool configuration may indicate a set of resources that are designated (e.g., reserved or assigned) for sidelink inter-UE coordination information. The sidelink inter-UE coordination information may be to assist other UEs with resource selection for sidelink transmissions. For example, the base station 110 may designate (e.g., reserve or assign) a subset of the second set of resources (e.g., a subset of the set of sidelink resources) for sidelink inter-UE coordination information. This subset of sidelink resources may then be used for transmission and reception of sidelink inter-UE coordination information and may not be used for other communications (e.g., other sidelink communications). In some aspects, resources that are not in the subset may be used for sidelink communications other than sidelink inter-UE coordination information, and/or may not be used for sidelink inter-UE coordination information.

In some aspects, such as when the designated resources are reserved resources, the first UE 710 and the second UE 720 may refrain from transmitting any communications, other than inter-UE coordination information, in the set of resources that are designated (e.g., reserved) for sidelink inter-UE coordination information. The set of resources may be excluded from use for communications other than inter-UE coordination information. Additionally, or alternatively, the first UE 710 and the second UE 720 may refrain from transmitting inter-UE coordination information in any resources that are not designated for sidelink inter-UE coordination information. Additionally, or alternatively, the first UE 710 and the second UE 720 may exclude the designated resources from a candidate resource set used during resource selection or resource reselection.

As shown by reference number 740, the first UE 710 may identify a set of resources that are designated for sidelink inter-UE coordination information, sometimes referred to herein as “inter-UE coordination resources.” In some aspects, the first UE 710 may identify the inter-UE coordination resources based at least in part on a sidelink resource pool configuration. In some aspects, the sidelink resource pool configuration is indicated to the first UE 710 by the base station 110, as shown in FIG. 7 and as described above in connection with reference number 730. However, in some aspects, the sidelink resource pool configuration may be hard coded in memory of the first UE 710 (e.g., stored in memory of the first UE 710 without being signaled to the first UE 710 by the base station). For example, the sidelink resource pool configuration may be hard coded in memory of the first UE 710 according to a wireless communication standard. Thus, the base station 110 may or may not signal the sidelink resource pool configuration to the first UE 710, as indicated by the dashed line in FIG. 7.

In some aspects, the sidelink resource pool configuration may indicate a number of sub-channels included in the set of inter-UE coordination resources, a time domain location of the set of inter-UE coordination resources, a frequency domain location of the set of inter-UE coordination resources, and/or a periodicity of the set of inter-UE coordination resources. As an example, and referring to FIG. 6, the sidelink resource pool configuration may indicate a single sub-channel, a frequency domain location for that sub-channel, a starting time domain location (e.g., a starting slot, which may be communicated as a slot offset or another value), and a time domain periodicity of two (e.g., indicating every other slot). Using the sidelink resource pool configuration, the first UE 710 and the second UE 720 may be enabled to identify the entire set of resources designated for inter-UE coordination information.

In some aspects, the sidelink resource pool configuration may indicate multiple sets of inter-UE coordination resources. In this example, different sets of resources may be associated with different priority levels. For example, a first set of inter-UE coordination resources may be associated with a first priority level, a second set of inter-UE coordination resources may be associated with a second priority level, and so on. In some aspects, a first set of inter-UE coordination resources that is associated with a higher priority may include a greater number of resources than a second set of inter-UE coordination resources that is associated with a lower priority level. In some aspects, different sets of inter-UE coordination resources may be mutually exclusive. In some aspects, different sets of inter-UE coordination resources may partially overlap. For example, the second set of inter-UE coordination resources that is associated with the lower priority level may be a subset of the first set of inter-UE coordination resources that is associated with the higher priority level.

Additionally, or alternatively, if the sidelink resource pool configuration indicates multiple sets of inter-UE coordination resources, then different sets of resources may be associated with different inter-UE coordination schemes (in some aspects, “different inter-UE coordination schemes” may be referred to as “different inter-UE coordination information”). For example, a first set of inter-UE coordination resources may be associated with a first inter-UE coordination scheme (or first inter-UE coordination information) that indicates preferred resources (e.g., where the inter-UE coordination information identifies resources that are preferred by the first UE 710 for transmissions of the second UE 720), a second set of inter-UE coordination resources may be associated with a second inter-UE coordination scheme (or second inter-UE coordination information) that indicates non-preferred resources (e.g., where the inter-UE coordination information identifies resources that are not preferred by the first UE 710 for transmissions of the second UE 720), and/or a third set of inter-UE coordination resources may be associated with a third inter-UE coordination scheme (or third inter-UE coordination information) that indicates a resource conflict (e.g., where the inter-UE coordination information identifies a resource conflict or a collision between communications of different UEs). The resource conflict may be in the time domain only, may be in both the time domain and the frequency domain, or may be in a time domain, a frequency domain, and a spatial domain

As shown by reference number 750, the second UE 720 may identify a set of resources that are designated for sidelink inter-UE coordination information in a similar manner as described above in connection with reference number 740 and the first UE 710.

As shown by reference number 760, the first UE 710 may transmit, to the second UE 720, a communication that includes inter-UE coordination information. The first UE 710 may transmit the communication in a resource (e.g., sometimes referred to herein as a “designated resource” or a “reserved resource”) of the set of resources designated for sidelink inter-UE coordination. For example, the first UE 710 may identify the set of inter-UE coordination resources and may select one or more resources, of the set of inter-UE coordination resources, for transmission of sidelink inter-UE coordination information. In some aspects, the first UE 710 may select the next-occurring resource, in the set of inter-UE coordination resources, for which the first UE 710 has sufficient processing time to transmit the sidelink inter-UE coordination information. The second UE 720 may monitor the set of resources designated for sidelink inter-UE coordination. For example, the second UE 720 may receive and decode communications in the set of resources to be able to receive the communication from the first UE 710 that includes inter-UE coordination information.

As shown by reference number 770, the second UE 720 may schedule one or more transmissions based at least in part on the inter-UE coordination information. For example, the second UE 720 may select a sidelink resource for a transmission from the second UE 720 based at least in part on a set of available resources indicated by the inter-UE coordination information. As a result, the inter-UE coordination signaling may reduce resource conflicts and collisions and may reduce a power consumption for the first UE 710 and/or the second UE 720 (e.g., due to fewer retransmissions as a result of fewer collisions).

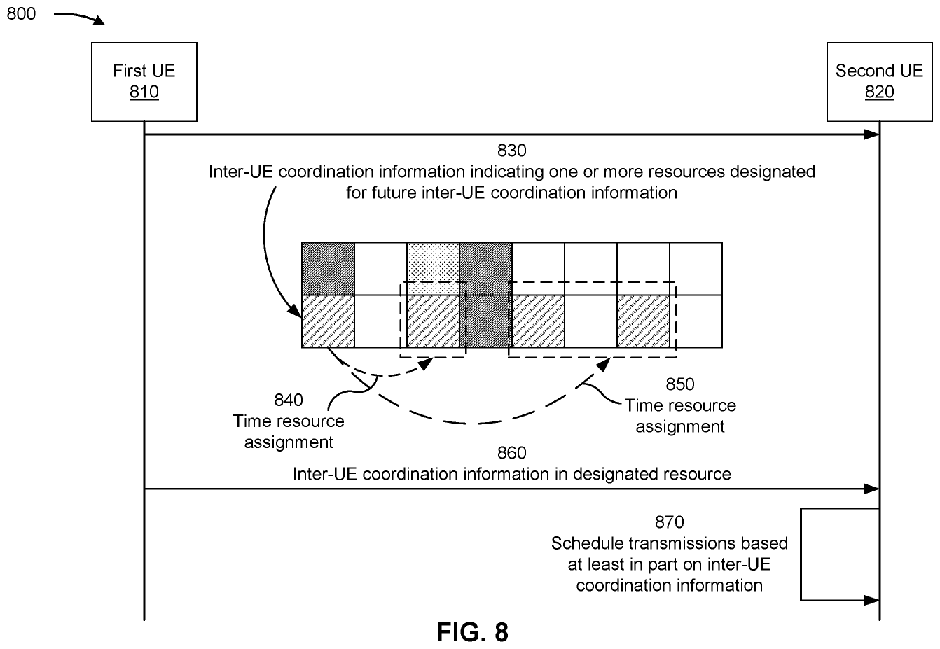

Designating sidelink resources for inter-UE communication information as described herein may reduce latency, may reduce resource conflicts, may conserve resources of the UE (e.g., memory resources, processing resources, and/or battery power), and/or may conserve network resources, as described in more detail elsewhere herein. In some aspects, the techniques described in connection with FIG. 7 may be used to notify UEs that are configured or enabled to communicate sidelink inter-UE coordination information of the resources designated for sidelink inter-UE coordination information. In some aspects, those UEs may indicate, in communications that include sidelink inter-UE coordination information, one or more other resources (e.g., later-occurring resources) that are also designated for sidelink inter-UE coordination information, as described in more detail below in connection with FIG. 8. As a result, UEs that are not configured or enabled to communicate sidelink inter-UE coordination information may be notified of resource designations or reservations, thereby providing backward compatibility for designating resources for sidelink inter-UE coordination information.

As indicated above, FIG. 7 is provided as an example. Other examples may differ from what is described with respect to FIG. 7.

FIG. 8 is a diagram illustrating an example 800 associated with sidelink inter-UE coordination using designated resources, in accordance with the present disclosure. As shown in FIG. 8, a first UE 810 and a second UE 820 may communicate with one another via a sidelink. In some aspects, the first UE 810 and/or the second UE 820 may also communication with a base station 110 via an access link, which is not shown in FIG. 8. The first UE 810 and the second UE 820 may be UEs 120 described elsewhere herein and/or may be the first UE 710 and the second UE 720, respectively.

As shown by reference number 830, the first UE 810 may transmit, and the second UE 820 may receive, a communication that includes inter-UE coordination information. As shown, the communication may indicate one or more resources that are designated for (e.g., future) sidelink inter-UE coordination information. For example, the communication may indicate one or more later-occurring resources, as compared to a resource in which the sidelink inter-UE coordination information, that are designated (e.g., reserved or assigned) for future transmission of inter-UE coordination information. In some aspects, the one or more resources may include up to two resources.

In a first example 840, the communication indicates a single future resource designated for sidelink inter-UE coordination information. In a second example 850, the communication indicates two future resources designated for sidelink inter-UE coordination information. In other examples, the communication indicates a different number of future resources designated for sidelink inter-UE coordination information.

In some aspects, a sidelink resource pool configuration (e.g., as described above in connection with FIG. 7) may indicate, to the first UE 810 and/or the second UE 820, a number of resources to be indicated as designated for sidelink inter-UE coordination information in the communication that includes the inter-UE coordination information. For example, the sidelink resource pool configuration may indicate that a single future designated resource is to be indicated in the communication, that two future designated resources are to be indicated, or that a different number of future designated resources are to be indicated. In this way, signaling overhead may be controlled, and processing resources used to identify and indicate future designated resources can be conserved.

Additionally, or alternatively, the sidelink resource pool configuration (e.g., as described above in connection with FIG. 7) may indicate, to the first UE 810 and/or the second UE 820, an offset between the communication, that includes the inter-UE coordination information, and an earliest occurring resource to be indicated in the one or more resources designated for inter-UE coordination information. For example, the sidelink resource pool configuration may indicate that designated resources that occur up to a threshold number of slots after the slot with the communication are not to be indicated in the communication, and that only designated resources that occur greater than (or equal to) a threshold number of slots are to be indicated in the communication. This may conserve signaling overhead by refraining from signaling designated resources that will occur before a receiving UE, that receives the communication, has finished processing the communication.

In some aspects, the first UE 810 may indicate the one or more resources designated for sidelink inter-UE coordination information in SCI-1 (e.g., transmitted via the PSCCH). For example, the first UE 810 may set a time resource assignment field and/or a resource reservation period field of SCI-1 to indicate the one or more resources designated for sidelink inter-UE coordination information. In some aspects, the first UE 810 may use the time resource assignment field (e.g., which is typically used to signal retransmissions) for a single (e.g., non-recurring) indication of a future designated resource. In some aspects, the first UE 810 may use the resource reservation period field to indicate recurring designated resources. In some aspects, the first UE 810 may use both fields to indicate a single instance of a designated resource and a recurring set of designated resources. The second UE 820 may identify the one or more resources designated for sidelink inter-UE coordination information by decoding SCI-1 (e.g., based at least in part on a value the time resource assignment field and/or the resource reservation period field).

In some aspects, a sidelink resource pool configuration (e.g., as described above in connection with FIG. 7) may indicate, to the first UE 810 and/or the second UE 820, whether the one or more designated resources are to be indicated using the time resource assignment field of SCI-1 and/or using the resource reservation period field of SCI-1. The first UE 810 may indicate the one or more designated resources according to the sidelink resource pool configuration, and the second UE 820 may interpret the SCI-1, to identify the one or more designated resources, according to the sidelink resource pool configuration.

In some aspects, such as when the one or more resources designated for sidelink inter-UE coordination information are indicated in SCI-1, the values of all fields of SCI-1 may be predefined. For example, the values may be predefined according to a sidelink resource pool configuration (e.g., that indicates fixed values to be used for each field or that indicates a calculation for determining the values to be used for each field). Additionally, or alternatively, the values may be hard coded in memory of the first UE 810 and/or the second UE 820 (e.g., according to a wireless communication standard, which may indicate a fixed value for a field or a calculation for determining a value for a field). In some aspects, a first set of the fields may have values that are predefined according to a sidelink resource pool configuration, and a second set of the fields may have values that are hard coded in memory of the UE (e.g., according to the wireless communication standard)

The fields in SCI-1 may include, for example, a priority field, a frequency resource assignment field, a time resource assignment field, a resource reservation period field, a DMRS pattern field, an SCI-2 format field, a beta offset field, a number of DMRS ports field, an MCS field, an additional MCS table indicator field, a PSFCH overhead indication field, and/or a reserved bits field. When the SCI-1 is used for a purpose other than to indicate one or more resources designated for sidelink inter-UE coordination information, the UE that transmits the SCI-1 may determine the values for the fields of SCI-1 (which may not be predefined). By predefining all fields of SCI-1 for SCI-1 that indicates one or more resources designated for sidelink inter-UE coordination information, all UEs that transmit inter-UE coordination information in the designated resources will transmit the same values in SCI-1. As a result, interference among inter-UE coordination information transmitted by different UEs may be reduced (and transmissions from different UEs may combine constructively), thereby enabling receiving UEs to more accurately decode SCI-1 to identify the one or more designated resources.

In some aspects, such as when the one or more resources designated for sidelink inter-UE coordination information are indicated via the PSCCH (e.g., in SCI-1), the communication that includes the inter-UE coordination information is transmitted with a DMRS to assist with demodulation. In some aspects, an orthogonal cover code (OCC), such as a frequency domain OCC (FD-OCC), applied to the DMRS is predefined. For example, the first UE 810 may apply a predefined OCC to the DMRS, and the second UE 820 may use the predefined OCC to process the DMRS. For example, the OCC may be predefined according to a sidelink resource pool configuration (e.g., that indicates a cyclic shift to be used for the OCC or that indicates a calculation for determining the OCC). Alternatively, the OCC may be hard coded in memory of the first UE 810 and/or the second UE 820 (e.g., according to a wireless communication standard, which may indicate a cyclic shift to be used for the OCC or a calculation for determining the OCC). In some aspects, the first UE 810 and/or the second UE 820 may determine the OCC as a function of the resource in which the communication, that includes the inter-UE coordination information, is transmitted (e.g., a slot index of the resource, a frequency domain index of the resource, and/or a resource block index of the resource). In some aspects, the OCC may be a value, a factor, or a coefficient, that is multiplied with one or more other values as part of a calculation to determine the DMRS to be applied to a PSCCH communication.

For communications on the PSCCH other than communications that include the inter-UE coordination information, the UE that transmits the PSCCH communication may randomly select the OCC (e.g., may select one out of three OCC options). By predefining the OCC for a PSCCH communication that indicates one or more resources designated for sidelink inter-UE coordination information, all UEs that transmit inter-UE coordination information in the designated resources will transmit the PSCCH communication using the same OCC. As a result, interference among inter-UE coordination information transmitted by different UEs may be reduced, thereby enabling receiving UEs to more accurately decode the PSCCH communication to identify the one or more designated resources.

In some aspects, such as when the one or more resources designated for sidelink inter-UE coordination information are indicated in SCI-1, a corresponding SCI-2 transmission (e.g., that corresponds to the SCI-1) on the PSSCH may include fields that are not relevant to sidelink inter-UE coordination information. For example, SCI-2 may carry information relevant to data communications. Because sidelink inter-UE coordination information includes control information rather than data, the SCI-2 fields applicable to data communications are not relevant for sidelink inter-UE coordination information. To account for this, in some aspects, the values of one or more fields (e.g., all fields, or all fields except for an MCS field) of SCI-2, associated with the communication that includes the sidelink inter-UE coordination information, may be predefined according to a sidelink resource pool configuration or according to information hard coded in memory of the UE, in a similar manner as described elsewhere herein in connection with SCI-1.

The fields in SCI-2 may include, for example, a HARQ process ID field, an NDI field, a redundancy version (RV) field, a source ID field, a destination ID field, and/or a cast type field. In some aspects, the values of all of these fields may be predefined when the SCI-2 is associated with a communication that includes sidelink inter-UE coordination information. Additionally, or alternatively, one or more of these fields may be absent from or excluded from the SCI-2 associated with a communication that includes sidelink inter-UE coordination information. In some aspects, the SCI-2 may include an MCS field with a value that indicates an MCS used for data transmission and/or used for TB size determination for the inter-UE coordination information. In some aspects, the value of the MCS field may not be predefined and may be determined by the UE transmitting the SCI-2. In some aspects, the value of the NDI field may be toggled based at least in part on a transmission index or a slot index associated with the SCI-2. In some aspects, a value of the source ID field may indicate a source ID of the UE transmitting the SCI-2. In some aspects, the cast type field may be based at least in part on an inter-UE coordination scheme used for the inter-UE coordination information. In this way, a receiving UE may be able to properly interpret SCI-2 that is associated with inter-UE coordination information.

In some aspects, such as when the designated resources are reserved resources, the first UE 810 and the second UE 820 may refrain from transmitting any communications, other than inter-UE coordination information, in the one or more resources that are designated (e.g., reserved) for sidelink inter-UE coordination information. Additionally, or alternatively, the first UE 810 and the second UE 820 may refrain from transmitting inter-UE coordination information in any resources that are not designated for sidelink inter-UE coordination information. Additionally, or alternatively, the first UE 710 and the second UE 720 may exclude the one or more designated resources from a candidate resource set used during resource selection or resource reselection.

As shown by reference number 860, the first UE 810 may transmit, to the second UE 820, a communication that includes inter-UE coordination information. The first UE 810 may transmit the communication in a resource (e.g., sometimes referred to herein as a “designated resource” or a “reserved resource”) of the one or more resources designated for sidelink inter-UE coordination. For example, the first UE 810 may identify the one or more inter-UE coordination resources and may select one or more of those resources for transmission of sidelink inter-UE coordination information. In some aspects, the first UE 810 may select the next-occurring resource, of the one or more inter-UE coordination resources, for which the first UE 810 has sufficient processing time to transmit the sidelink inter-UE coordination information. The second UE 820 may monitor the one or more resources designated for sidelink inter-UE coordination. For example, the second UE 820 may receive and decode communications in the one or more resources to be able to receive the communication from the first UE 810 that includes inter-UE coordination information.

As shown by reference number 870, the second UE 820 may schedule one or more transmissions based at least in part on the inter-UE coordination information. For example, the second UE 820 may select a sidelink resource for a transmission from the second UE 820 based at least in part on a set of available resources indicated by the inter-UE coordination information. As a result, the inter-UE coordination signaling may reduce resource conflicts and collisions and may reduce a power consumption for the first UE 810 and/or the second UE 820 (e.g., due to fewer retransmissions as a result of fewer collisions).

Designating sidelink resources for inter-UE communication information as described herein may reduce latency, may reduce resource conflicts, may conserve resources of the UE (e.g., memory resources, processing resources, and/or battery power), and/or may conserve network resources, as described in more detail elsewhere herein. Furthermore, some techniques and apparatuses described herein enable UEs that are not configured or enabled to communicate sidelink inter-UE coordination information to be notified of resource reservations or designations, thereby providing backward compatibility for designating resources for sidelink inter-UE coordination information.

As indicated above, FIG. 8 is provided as an example. Other examples may differ from what is described with respect to FIG. 8.

FIG. 9 is a diagram illustrating an example process 900 performed, for example, by a UE, in accordance with the present disclosure. Example process 900 is an example where the UE (e.g., UE 120) performs operations associated with sidelink inter-UE coordination using designated resources.

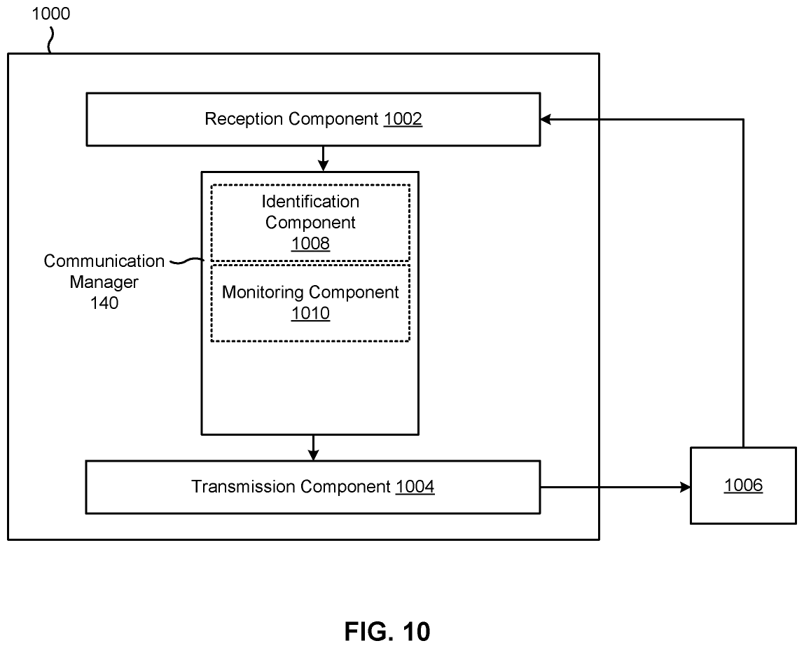

As shown in FIG. 9, in some aspects, process 900 may include identifying a set of resources that are designated for sidelink inter-UE coordination information based at least in part on a sidelink resource pool configuration (block 910). For example, the UE (e.g., using communication manager 140 and/or identification component 1008, depicted in FIG. 10) may identify a set of resources that are designated for sidelink inter-UE coordination information based at least in part on a sidelink resource pool configuration, as described above.

As further shown in FIG. 9, in some aspects, process 900 may include transmitting or monitoring for a communication that includes inter-UE coordination information in a resource of the set of resources (block 920). For example, the UE (e.g., using communication manager 140, transmission component 1004, reception component 1002, and/or monitoring component 1010, depicted in FIG. 10) may transmit or monitor for a communication that includes inter-UE coordination information in a resource of the set of resources, as described above.

Process 900 may include additional aspects, such as any single aspect or any combination of aspects described below and/or in connection with one or more other processes described elsewhere herein.

In a first aspect, process 900 includes refraining from transmitting any communications other than inter-UE coordination information in the set of resources.

In a second aspect, alone or in combination with the first aspect, the sidelink resource pool configuration is indicated to the UE by a base station or stored in memory of the UE.

In a third aspect, alone or in combination with one or more of the first and second aspects, the sidelink resource pool configuration indicates at least one of a number of sub-channels included in the set of resources, a time domain location of the set of resources, a frequency domain location of the set of resources, a periodicity of the set of resources, or a combination thereof.

In a fourth aspect, alone or in combination with one or more of the first through third aspects, the sidelink resource pool configuration indicates multiple sets of resources, and different sets of resources, of the multiple sets of resources, are associated with different priority levels.

In a fifth aspect, alone or in combination with one or more of the first through fourth aspects, the sidelink resource pool configuration indicates multiple sets of resources, and different sets of resources, of the multiple sets of resources, are associated with different inter-UE coordination schemes.

In a sixth aspect, alone or in combination with one or more of the first through fifth aspects, the different inter-UE coordination schemes include at least one of a first inter-UE coordination scheme that indicates preferred resources, a second inter-UE coordination scheme that indicates non-preferred resources, or a third inter-UE coordination scheme that indicates a resource conflict.

In a seventh aspect, alone or in combination with one or more of the first through sixth aspects, the communication that includes the inter-UE coordination information indicates one or more resources that are designated for sidelink inter-UE coordination information.

In an eighth aspect, alone or in combination with one or more of the first through seventh aspects, process 900 includes refraining from transmitting any communications other than inter-UE coordination information in the one or more resources.

In a ninth aspect, alone or in combination with one or more of the first through eighth aspects, the one or more resources are indicated using at least one of a time resource assignment field of SCI-1 or a resource reservation period field of SCI-1.

In a tenth aspect, alone or in combination with one or more of the first through ninth aspects, the sidelink resource pool configuration indicates at least one of whether to indicate the one or more resources using a time resource assignment field of SCI-1 or a resource reservation period field of SCI-1, a number of resources to be indicated as designated for sidelink inter-UE coordination information in the communication that includes the inter-UE coordination information, or an offset between the communication, that includes the inter-UE coordination information, and an earliest occurring resource to be indicated in the one or more resources.

In an eleventh aspect, alone or in combination with one or more of the first through tenth aspects, the communication that includes the inter-UE coordination information includes SCI-1, and values of all fields of the SCI-1 are predefined.

In a twelfth aspect, alone or in combination with one or more of the first through eleventh aspects, the communication that includes the inter-UE coordination information is transmitted with a DMRS, and an orthogonal cover code applied to the DMRS is predefined.

In a thirteenth aspect, alone or in combination with one or more of the first through twelfth aspects, the orthogonal cover code is predefined.

In a fourteenth aspect, alone or in combination with one or more of the first through thirteenth aspects, the communication that includes the inter-UE coordination information is associated with SCI-2, and values of one or more fields of the SCI-2 are predefined.

In a fifteenth aspect, alone or in combination with one or more of the first through fourteenth aspects, the communication that includes the inter-UE coordination information is associated with SCI-2, and the SCI-2 includes a field that indicates a modulation and coding scheme used for data transmission or transport block size determination for the inter-UE coordination information.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a block diagram of an example apparatus 1000 for wireless communication. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 140. The communication manager 140 may include one or more of an identification component 1008 or a monitoring component 1010, among other examples.

In some aspects, the apparatus 1000 may be configured to perform one or more operations described herein in connection with FIGS. 7-8. Additionally, or alternatively, the apparatus 1000 may be configured to perform one or more processes described herein, such as process 900 of FIG. 9. In some aspects, the apparatus 1000 and/or one or more components shown in FIG. 10 may include one or more components of the UE described above in connection with FIG. 2. Additionally, or alternatively, one or more components shown in FIG. 10 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a demodulator, a MIMO detector, a receive processor, a controller/processor, a memory, or a combination thereof, of the UE described above in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modulator, a transmit MIMO processor, a transmit processor, a controller/processor, a memory, or a combination thereof, of the UE described above in connection with FIG. 2. In some aspects, the transmission component 1004 may be co-located with the reception component 1002 in a transceiver.

The identification component 1008 may identify a set of resources that are designated for sidelink inter-UE coordination information based at least in part on a sidelink resource pool configuration. The transmission component 1004 may transmit a communication that includes inter-UE coordination information in a resource of the set of resources. The reception component 1002 and/or the monitoring component 1010 may monitor for a communication that includes inter-UE coordination information in a resource of the set of resources. The transmission component 1004 may refrain from transmitting any communications other than inter-UE coordination information in the set of resources.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a user equipment (UE), comprising: identifying a set of resources that are designated for sidelink inter-UE coordination information based at least in part on a sidelink resource pool configuration; and transmitting or monitoring for a communication that includes inter-UE coordination information in a resource of the set of resources.

Aspect 2: The method of Aspect 1, further comprising refraining from transmitting any communications other than inter-UE coordination information in the set of resources.

Aspect 3: The method of any of Aspects 1-2, wherein the sidelink resource pool configuration is indicated to the UE by a base station or stored in memory of the UE.

Aspect 4: The method of any of Aspects 1-3, wherein the sidelink resource pool configuration indicates at least one of a number of sub-channels included in the set of resources, a time domain location of the set of resources, a frequency domain location of the set of resources, a periodicity of the set of resources, or a combination thereof.

Aspect 5: The method of any of Aspects 1-4, wherein the sidelink resource pool configuration indicates multiple sets of resources, and wherein different sets of resources, of the multiple sets of resources, are associated with different priority levels.

Aspect 6: The method of any of Aspects 1-5, wherein the sidelink resource pool configuration indicates multiple sets of resources, and wherein different sets of resources, of the multiple sets of resources, are associated with different inter-UE coordination schemes.

Aspect 7: The method of Aspect 6, wherein the different inter-UE coordination schemes include at least one of a first inter-UE coordination scheme that indicates preferred resources, a second inter-UE coordination scheme that indicates non-preferred resources, or a third inter-UE coordination scheme that indicates a resource conflict.

Aspect 8: The method of any of Aspects 1-7, wherein the communication that includes the inter-UE coordination information indicates one or more resources that are designated for sidelink inter-UE coordination information.

Aspect 9: The method of Aspect 8, further comprising refraining from transmitting any communications other than inter-UE coordination information in the one or more resources.

Aspect 10: The method of any of Aspects 8-9, wherein the one or more resources are indicated using at least one of a time resource assignment field of first stage sidelink control information (SCI-1) or a resource reservation period field of SCI-1.

Aspect 11: The method of any of Aspects 8-10, wherein the sidelink resource pool configuration indicates at least one of: whether to indicate the one or more resources using a time resource assignment field of first stage sidelink control information (SCI-1) or a resource reservation period field of SCI-1, a number of resources to be indicated as designated for sidelink inter-UE coordination information in the communication that includes the inter-UE coordination information, or an offset between the communication, that includes the inter-UE coordination information, and an earliest occurring resource to be indicated in the one or more resources.

Aspect 12: The method of any of Aspects 1-11, wherein the communication that includes the inter-UE coordination information includes first stage sidelink control information (SCI-1), and wherein values of all fields of the SCI-1 are predefined.

Aspect 13: The method of any of Aspects 1-12, wherein the communication that includes the inter-UE coordination information is transmitted with a demodulation reference signal (DMRS), and wherein an orthogonal cover code applied to the DMRS is predefined.

Aspect 14: The method of Aspect 13, wherein the orthogonal cover code is predefined.

Aspect 15: The method of any of Aspects 1-14, wherein the communication that includes the inter-UE coordination information is associated with second stage sidelink control information (SCI-2), and wherein values of one or more fields of the SCI-2 are predefined.

Aspect 16: The method of any of Aspects 1-15, wherein the communication that includes the inter-UE coordination information is associated with second stage sidelink control information (SCI-2), and wherein the SCI-2 includes a field that indicates a modulation and coding scheme used for data transmission or transport block size determination for the inter-UE coordination information.

Aspect 17: An apparatus for wireless communication at a device, comprising a processor; memory coupled with the processor; and instructions stored in the memory and executable by the processor to cause the apparatus to perform the method of one or more of Aspects 1-16.

Aspect 18: A device for wireless communication, comprising a memory and one or more processors coupled to the memory, the one or more processors configured to perform the method of one or more of Aspects 1-16.

Aspect 19: An apparatus for wireless communication, comprising at least one means for performing the method of one or more of Aspects 1-16.

Aspect 20: A non-transitory computer-readable medium storing code for wireless communication, the code comprising instructions executable by a processor to perform the method of one or more of Aspects 1-16.

Aspect 21: A non-transitory computer-readable medium storing a set of instructions for wireless communication, the set of instructions comprising one or more instructions that, when executed by one or more processors of a device, cause the device to perform the method of one or more of Aspects 1-16.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a user equipment (UE), comprising:
identifying a set of resources that are designated for sidelink inter-UE coordination information based at least in part on a sidelink resource pool configuration, wherein the set of resources are excluded from use for communications other than inter-UE coordination information; and
transmitting a communication that includes inter-UE coordination information in a resource of the set of resources, wherein the inter-UE coordination information is to assist other UEs with resource selection for sidelink transmissions.

2. The method of claim 1, wherein the sidelink resource pool configuration is indicated to the UE by a base station.

3. The method of claim 1, wherein the sidelink resource pool configuration is stored in memory of the UE.

4. The method of claim 1, wherein the sidelink resource pool configuration indicates at least one of a number of sub-channels included in the set of resources, a time domain location of the set of resources, a frequency domain location of the set of resources, a periodicity of the set of resources, or a combination thereof.

5. The method of claim 1, wherein the sidelink resource pool configuration indicates multiple sets of resources, and wherein different sets of resources, of the multiple sets of resources, are associated with different priority levels.

6. The method of claim 1, wherein the sidelink resource pool configuration indicates multiple sets of resources, and wherein different sets of resources, of the multiple sets of resources, are associated with different inter-UE coordination schemes, and wherein the different inter-UE coordination schemes include at least one of a first inter-UE coordination scheme that indicates preferred resources, a second inter-UE coordination scheme that indicates non-preferred resources, or a third inter-UE coordination scheme that indicates a resource conflict.

7. The method of claim 1, wherein the communication that includes the inter-UE coordination information indicates one or more resources that are designated for sidelink inter-UE coordination information.

8. The method of claim 7, further comprising refraining from transmitting any communications other than inter-UE coordination information in the one or more resources.

9. The method of claim 7, wherein the one or more resources are indicated using at least one of a time resource assignment field of first stage sidelink control information (SCI-1) or a resource reservation period field of SCI-1.

10. The method of claim 7, wherein the sidelink resource pool configuration indicates at least one of:
whether to indicate the one or more resources using a time resource assignment field of first stage sidelink control information (SCI-1) or a resource reservation period field of SCI-1,
a number of resources to be indicated as designated for sidelink inter-UE coordination information in the communication that includes the inter-UE coordination information, or
an offset between the communication, that includes the inter-UE coordination information, and an earliest occurring resource to be indicated in the one or more resources.

11. The method of claim 1, wherein the communication that includes the inter-UE coordination information includes first stage sidelink control information (SCI-1), and wherein values of all fields of the SCI-1 are predefined.

12. The method of claim 1, wherein the communication that includes the inter-UE coordination information is transmitted with a demodulation reference signal (DMRS), and wherein an orthogonal cover code applied to the DMRS is predefined.

13. The method of claim 1, wherein the communication that includes the inter-UE coordination information is associated with second stage sidelink control information (SCI-2), and wherein values of one or more fields of the SCI-2 are predefined.

14. The method of claim 1, wherein the communication that includes the inter-UE coordination information is associated with second stage sidelink control information (SCI-2), and wherein the SCI-2 includes a field that indicates a modulation and coding scheme used for data transmission or transport block size determination for the inter-UE coordination information.

15. An apparatus of a user equipment (UE) for wireless communication, comprising:
a memory; and
one or more processors, coupled to the memory, configured to:
identify a set of resources that are designated for sidelink inter-UE coordination information based at least in part on a sidelink resource pool configuration, wherein the set of resources are excluded from use for communications other than inter-UE coordination information; and
transmit a communication that includes inter-UE coordination information in a resource of the set of resources, wherein the inter-UE coordination information is to assist other UEs with resource selection for sidelink transmissions.

16. The apparatus of claim 15, wherein the sidelink resource pool configuration is indicated to the UE by a base station.

17. The apparatus of claim 15, wherein the sidelink resource pool configuration is stored in memory of the UE.

18. The apparatus of claim 15, wherein the sidelink resource pool configuration indicates at least one of a number of sub-channels included in the set of resources, a time domain location of the set of resources, a frequency domain location of the set of resources, a periodicity of the set of resources, or a combination thereof.

19. The apparatus of claim 15, wherein the sidelink resource pool configuration indicates multiple sets of resources, and wherein different sets of resources, of the multiple sets of resources, are associated with different priority levels.

20. The apparatus of claim 15, wherein the sidelink resource pool configuration indicates multiple sets of resources, and wherein different sets of resources, of the multiple sets of resources, are associated with different inter-UE coordination schemes, and wherein the different inter-UE coordination schemes include at least one of a first inter-UE coordination scheme that indicates preferred resources, a second inter-UE coordination scheme that indicates non-preferred resources, or a third inter-UE coordination scheme that indicates a resource conflict.

21. The apparatus of claim 15, wherein the communication that includes the inter-UE coordination information indicates one or more resources that are designated for sidelink inter-UE coordination information.

22. The apparatus of claim 21, wherein the one or more processors are further configured to refrain from transmitting any communications other than inter-UE coordination information in the one or more resources.

23. The apparatus of claim 21, wherein the one or more resources are indicated using at least one of a time resource assignment field of first stage sidelink control information (SCI-1) or a resource reservation period field of SCI-1.

24. The apparatus of claim 21, wherein the sidelink resource pool configuration indicates at least one of:
whether to indicate the one or more resources using a time resource assignment field of first stage sidelink control information (SCI-1) or a resource reservation period field of SCI-1,
a number of resources to be indicated as designated for sidelink inter-UE coordination information in the communication that includes the inter-UE coordination information, or
an offset between the communication, that includes the inter-UE coordination information, and an earliest occurring resource to be indicated in the one or more resources.

25. The apparatus of claim 15, wherein the communication that includes the inter-UE coordination information includes first stage sidelink control information (SCI-1), and wherein values of all fields of the SCI-1 are predefined.

26. The apparatus of claim 15, wherein the communication that includes the inter-UE coordination information is transmitted with a demodulation reference signal (DMRS), and wherein an orthogonal cover code applied to the DMRS is predefined.

27. The apparatus of claim 15, wherein the communication that includes the inter-UE coordination information is associated with second stage sidelink control information (SCI-2), and wherein values of one or more fields of the SCI-2 are predefined.

28. The apparatus of claim 15, wherein the communication that includes the inter-UE coordination information is associated with second stage sidelink control information (SCI-2), and wherein the SCI-2 includes a field that indicates a modulation and coding scheme used for data transmission or transport block size determination for the inter-UE coordination information.

29. A non-transitory computer-readable medium storing a set of instructions for wireless communication, the set of instructions comprising:
one or more instructions that, when executed by one or more processors of a user equipment (UE), cause the UE to:
identify a set of resources that are designated for sidelink inter-UE coordination information based at least in part on a sidelink resource pool configuration, wherein the set of resources are excluded from use for communications other than inter-UE coordination information; and
transmit a communication that includes inter-UE coordination information in a resource of the set of resources, wherein the inter-UE coordination information is to assist other UEs with resource selection for sidelink transmissions.

30. An apparatus for wireless communication, comprising:
means for identifying a set of resources that are designated for sidelink inter-user equipment (UE) coordination information based at least in part on a sidelink resource pool configuration, wherein the set of resources are excluded from use for communications other than inter-UE coordination information; and
means for transmitting a communication that includes inter-UE coordination information in a resource of the set of resources, wherein the inter-UE coordination information is to assist other UEs with resource selection for sidelink transmissions.
